(19) United States
(12) Patent Application Publication
(10) Pub. No.: US 2014/0297653 A1
(43) Pub. Date: Oct. 2, 2014

(54) ONTOLOGY-BASED QUERY METHOD AND APPARATUS

(71) Applicant: NEC (China) Co., Ltd., Beijing (CN)

(72) Inventors: Bo Liu, Beijing (CN); Jianqiang Li, Beijing (CN); Chunchen Liu, Beijing (CN)

(73) Assignee: NEC (China) Co., Ltd., Beijing (CN)

(21) Appl. No.: 14/203,765

(22) Filed: Mar. 11, 2014

(30) Foreign Application Priority Data
Mar. 27, 2013 (CN) 201310102702.6

(51) Int. Cl. G06F 17/30

(52) U.S. Cl. CPC G06F 17/30734; G06F 2216/03
USPC 707/747

(57) ABSTRACT

An ontology-based query method and apparatus include acquiring a to-be-queried triple input by the user, where a known element is a query condition. One or more unknown elements in the to-be-queried triple is a query object and searching is performed, in the key-value pairs stored in each of the plurality of computing nodes, for a key-value pair matching the query condition. An element corresponding to the query object is determined from three elements included in a key value of the matched key-value pair, to acquire elements corresponding to the query objects determined in each of the plurality of computing nodes. A query result is acquired according to the elements corresponding to the query objects determined in each of the plurality of computing nodes.

### TECHNICAL FIELD

The present disclosure relates to the field of information retrieval, and in particular, to an ontology-based query method and apparatus.

### BACKGROUND

Data query is an important means for acquiring desired data. In the traditional query method, after a user inputs a query keyword, a computing node directly matches the query keyword with the data in a database, and acquires a query result. For example, after the user inputs keyword “Zhang San”, the computing node sends the data in the database matching the keyword “Zhang San” to the user, for example, photos, personal websites, or thesis of Zhang San. However, if the user desires to acquire a more accurate query result, for example, contact address of Zhang San, the traditional query method does not work. For a more accurate query result, an ontology-based query method is provided. The ontology is a description of a relation between two entities in the real world. The ontology may be described in a plurality of manners. A Resource Description Framework (RDF) is a most-widely used one. The ontology described by an RDF is constructed by a plurality of triples. One triple is formed by three elements: resource, attribute value, and attribute, which are also referred to as subject, object, and predicate describing a relation between the subject and the object. In addition, the subject/object/predicate of one triple may be the subject/object/predicate of another triple. During storing the ontology described by the RDF in the computing node, in addition to storing the elements, a corresponding set of logical relations therebetween also needs to be stored to enable the computing node to identify relations between the elements. The elements and the logical relations therebetween may be described as RDF graphs as illustrated in FIG. 1. In an ontology-based query, a query result better satisfying user requirements is returned according to a relation between keywords input by the user. Therefore, the ontology-based query has become a research hotspot in the field of information retrieval.

The paper A Semantic-aware RDF Query Algebra published on the International Conference on Management of Data, COMAD 2005b, by Li Chen, Amarnath Gupta, and M. Erdem Kurul in 2005 has disclosed an ontology-based query method. The method includes: pre-storing the ontology described by an RDF in a computing node in the form of an RDF graph, including various elements and corresponding relations therebetween of the RDF; acquiring a to-be-queried triple input by a user, where a known element in the to-be-queried triple is a query condition and an unknown element is a query object; randomly selecting an element from an RDF graph, acquiring positions of the elements in the RDF graph by reasoning based on the pre-stored logical relations, and if the position of an element in the RDF graph is the same as the position of a known element of the query condition in the triple, comparing the known element with the element in the RDF graph; starting from the element in the RDF graph, acquiring a next element whose position is the same as the position of the known element in the triple by reasoning based on the logical relations, comparing the known element with the next element in the RDF graph before traversing the entire RDF graph, and recording elements in the RDF graph matching the known element; according to the position of the known element in the triple, acquiring a triple where the matched elements in the RDF graph by reasoning based on the logical relations; determining a triple corresponding to the query condition according to the other known elements of the query condition; and determining elements corresponding to the query condition from the triple corresponding to the query condition, and using the determined elements as the query result.

For example, the RDF graph as illustrated in FIG. 1 is pre-stored in a computing node, where the RDF graph includes various elements and corresponding logical relations between various elements in the RDF; when the user desires to query the contact address of Zhang San, the user inputs a to-be-queried triple (S=Zhang San, P=contact address, O=?) to the computing node, where the known elements subject “Zhang San” and predicate “contact address” in the to-be-queried triple are the query condition, the unknown element object “O” is the query object. After acquiring the to-be-queried triple input by the user, the computing node randomly selects an element “science and technology periodicals” as a starting point, acquires element “science and technology periodicals” as the subject by reasoning based on the pre-stored logical relations, and then compares the known element subject “Zhang San” of the query condition with the “science and technology periodicals”. The computing node, starting from the “science and technology periodicals”, continues to acquire a next element serving as the subject by reasoning based on the logical relations, and compares the acquired element with the known element subject “Zhang San” before traversing the entire RDF graph. The computing node records the element subject “Zhang San” in the RDF graph matching the known element subject “Zhang San”, and acquires, by reasoning based on the logical relations, the triples

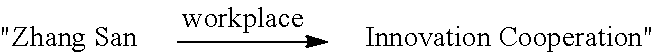

and

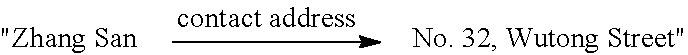

where the element subject “Zhang San” is located; the computing node determines, according to another known element predicate “contact address”, that the triple corresponding to the query condition is

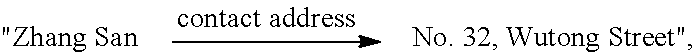

determines, according to the query object and from the determined triple, that the element corresponding to the query object is object “No. 32, Wutong Street”, and uses object “No. 32, Wutong Street” as the query result.

During the implementation of the present disclosure, the inventors find that the prior art has at least the following problems:

According to the ontology-based query method in the prior art, since the ontology described by an RDF is stored in the form of an RDF graph, during traversing the RDF graph to search for elements in the RDF graph, reasoning operations based on the logical relations between the elements in the RDF graph are needed. Therefore, the traversing the RDF graph takes a long time, causing a low query speed. In addition, during traversing the RDF graph, the RDF graph is generally stored in one computing node for uninterrupted logical reasoning. Consequently, with enlargement of the RDF graph, the logical relations in the RDF graph are becoming more complex. In this way, the reasoning takes even longer, and the query speed is greatly lowered.

### SUMMARY

To solve the technical problems in the prior art, embodiments of the present disclosure provide an ontology-based query method and apparatus. The technical solutions are as follows:

In one aspect, an ontology-based query method is provided, where a plurality of key-value pairs constructed according to a triple of the ontology described with an RDF are stored in a plurality of computing nodes respectively, each of the plurality of key-value pairs including a key and a key value, the key value including three elements of the triple, and the key including one of the three elements of the triple, the method including:

acquiring at least one to-be-queried triple input by the user, where a known element in the to-be-queried triple is a query condition, and at least one unknown element in the to-be-queried triple is a query object;

searching, in the key-value pairs stored in each of the plurality of computing nodes, for at least one key-value pair matching the query condition, and determining an element corresponding to the query object from three elements included in a key value of the matched key-value pair, to acquire elements corresponding to the query objects determined in each of the plurality of computing nodes; and

acquiring a query result according to the elements corresponding to the query objects determined in each of the plurality of computing nodes.

Specifically, if there is one known element in the to-be-queried triple, and the query condition is the one known element in the to-be-queried triple, the searching, in the key-value pairs stored in each of the plurality of computing nodes, for at least one key-value pair matching the query condition includes:

searching, in keys of the key-value pairs stored in each of the plurality of computing nodes, for at least one key matching a known element of the query condition, and using at least one key-value pair corresponding to the matched key as key-value pair matching the query condition.

Specifically, if there are two known elements in the to-be-queried triple, and the query condition is the two known elements in the to-be-queried triple, the searching, in the key-value pairs stored in each of the plurality of computing nodes, for at least one key-value pair matching the query condition includes:

searching, in keys of the key-value pairs stored in each of the plurality of computing nodes, for at least one key matching a known element of the query condition; and

searching, in key values corresponding to the matched key, for at least one key value matching another known element of the query condition, and using at least one key value pair corresponding to the matched key value as key-value pair matching the query condition.

Specifically, the acquiring a query result according to the elements corresponding to the query objects determined in each of the plurality of computing nodes includes:

Combining the elements corresponding to the query objects determined in each of the plurality of computing nodes to acquire the query result.

Specifically, if there are two known elements in the to-be-queried triple, and the query condition is the two known elements in the to-be-queried triple, the searching, in the key-value pairs stored in each of the plurality of computing nodes, for at least one key-value pair matching the query condition includes:

searching, in keys of the key-value pairs stored in each of the plurality of computing nodes, for at least one key matching a known element of the query condition and searching, in keys of the key-value pairs stored in each of the plurality of computing nodes, for at least one key matching another known element of the query condition, and using at least one key-value pair corresponding to the at least one key matching the one known element and at least one key-value pair corresponding to the at least one key matching the another known element as key-value pair matching the query condition.

Specifically, the acquiring a query result according to the elements corresponding to the query objects determined in each of the plurality of computing nodes includes:

categorizing the elements corresponding to the query objects determined in each of the plurality of computing nodes according to the known elements of the query conditions to acquire elements corresponding to the query objects acquired according to each of the known elements of the query conditions; and

taking an intersection of the elements corresponding to the query objects acquired according to each of the known elements of the query conditions to acquire the query result.

Specifically, if there are a plurality of to-be-queried triples, the acquiring a query result according to the elements corresponding to the query objects determined in each of the plurality of computing nodes includes:

acquiring the query result according to a relation between each two of the plurality of to-be-queried triples and the elements corresponding to the query objects determined in each of the plurality of computing nodes for each of the plurality of to-be-queried triples.

Specifically, the acquiring the query result according to a relation between each two of the plurality of to-be-queried triples and the elements corresponding to the query objects determined in each of the plurality of computing nodes for each of the plurality of to-be-queried triples includes:

if the relation between each two of the plurality of to-be-queried triples is an AND relation, taking an intersection of the elements corresponding to the query objects determined in each of the plurality of computing nodes for each of the plurality of to-be-queried triples to acquire the query result; and

if the relation between each two of the plurality of to-be-queried triples is an OR relation, taking a union of the elements corresponding to the query objects determined in each of the plurality of computing nodes for each of the plurality of to-be-queried triples to acquire the query result.

Furthermore, the method further includes:

constructing the plurality of key-value pairs according to the ontology described by the RDF, and storing the constructed plurality of key-value pairs in the plurality of computing nodes.

Specifically, the storing the constructed plurality of key-value pairs in the plurality of computing nodes includes:

if there are at least two key-value pairs, whose keys and corresponding key values are the same, in the constructed plurality of key-value pairs, storing at least one of the at least two key-value pairs in the plurality of computing nodes.

Specifically, the storing the constructed plurality of key-value pairs in the plurality of computing nodes includes:

storing key-value pairs of the constructed plurality of key-value pairs, whose key values are the same, in the same computing node.

In another aspect, an ontology-based query apparatus is provided, where a plurality of key-value pairs constructed according to a triple of the ontology described with an RDF are stored in a plurality of computing nodes respectively, each of the plurality of key-value pairs including a key and a key value, the key value including three elements of the triple, and the key including one of the three elements of the triple, the apparatus including:

a first acquiring module, configured to acquire at least one to-be-queried triple input by the user, where a known element in the to-be-queried triple is a query condition, and at least one unknown element in the to-be-queried triple is a query object;

a searching module, configured to search, in the key-value pairs stored in each of the plurality of computing nodes, for at least one key-value pair matching the query condition acquired by the first acquiring module;

a first determining module, configured to determine an element corresponding to the query object from three elements comprised in a key value of the matched key-value pair acquired by the searching module, to acquire elements corresponding to the query objects determined in each of the plurality of computing nodes;

a second acquiring module, configured to acquire a query result according to the elements corresponding to the query objects determined by the first determining module in each of the plurality of computing nodes.

Specifically, if there is one known element in the to-be-queried triple, and the query condition is the one known element in the to-be-queried triple, the searching module is configured to search, in keys of the key-value pairs stored in each of the plurality of computing nodes, for at least one key matching a known element of the query condition, and use at least one key-value pair corresponding to the matched key as key-value pair matching the query condition.

If there are two known elements in the to-be-queried triple, and the query condition is the two known elements in the to-be-queried triple, the searching module includes:

a first searching unit, configured to search, in the key-value pairs stored in each of the plurality of computing nodes, for at least one key matching a known element of the query condition; and

a second searching unit, configured to search, in keys of key values corresponding to the matched key searched by the first searching unit, for at least one key value matching another known element of the query condition, and use at least one key-value pair corresponding to the matched key value as key-value pair matching the query condition.

Specifically, the second acquiring module is configured to combine the elements corresponding to the query objects determined in each of the plurality of computing nodes to acquire the query result.

Specifically, if there are two known elements in the to-be-queried triple, and the query condition is the two known elements in the to-be-queried triple, the searching module is configured to search, in keys of the key-value pairs stored in each of the plurality of computing nodes, for at least one key matching a known element of the query condition and search, in keys of the key-value pairs stored in each of the plurality of computing nodes, for at least one key matching another known element of the query condition, and use at least one key-value pair corresponding to the at least one key matching the one known element and at least one key-value pair corresponding to the at least one keys matching the another known element as key-value pair matching the query condition.

Specifically, the second acquiring module includes:

a categorizing unit, configured to categorize the elements corresponding to the query objects determined in each of the plurality of computing nodes according to the known elements of the query conditions to acquire elements corresponding to the query objects acquired according to each of the known elements of the query conditions; and

the first acquiring unit, configured to take an intersection of the elements corresponding to the query objects acquired by the categorizing unit according to each of the known elements of the query conditions to acquire the query result.

If there is a plurality of to-be-queried triples, the second acquiring module is configured to acquire the query result according to a relation between each two of the plurality of to-be-queried triples and the elements corresponding to the query objects determined in each of the plurality of computing nodes for each of the plurality of to-be-queried triples.

Specifically, the second acquiring module includes:

a second acquiring unit, configured to: take an intersection of the elements corresponding to the query objects determined in each of the plurality of computing nodes for each of the plurality of to-be-queried triples to acquire the query result if the relation between each two of the plurality of to-be-queried triples is an AND relation; and

a third acquiring unit, configured to: take a union of the elements corresponding to the query objects determined in each of the plurality of computing nodes for each of the plurality of to-be-queried triples to acquire the query result if the relation between each two of the plurality of to-be-queried triples is an OR relation.

Furthermore, the device further includes:

a constructing module, configured to construct the plurality of key-value pairs according to the ontology described by the RDF; and

a storing module, configured to store the plurality of key-value pairs constructed by the constructing module in the plurality of computing nodes.

Specifically, the storing module is configured to: if there are at least two key-value pairs, whose keys and corresponding key values are the same, in the constructed plurality of key-value pairs, store at least one of the at least two key-value pairs in the plurality of computing nodes.

Specifically, the storing module is configured to: store key-value pairs of the constructed plurality of key-value pairs, whose key values are the same, in the same computing node.

The technical solutions provided in the embodiments of the present disclosure achieve the following beneficial effects:

The ontology described by an RDF is pre-constructed into a plurality of key-value pairs, and the key-value pairs are stored in a plurality of computing nodes. When a user performs a query operation, the user searches, in the key-value pairs stored in each of the plurality of computing nodes, for at least one key-value pair matching the query condition, determines an element corresponding to the query object from three elements comprised in a key value of the matched key-value pair, and acquires a query result according to the determined elements. In this way, a novel manner for storing the ontology described by the RDF is provided. Furthermore, since the stored key-value pairs are independent of each other, matched key-value pairs may be searched in the stored key-value pairs directly according to the query condition to acquire a query result. This prevents complex reasoning operations, and thus the query speed is improved. In addition, enlarging the ontology described by the RDF causes minor impacts on the query speed. Furthermore, since the key-value pairs are stored in the plurality of computing nodes, the searching may be performed in the plurality of computing nodes in parallel, thereby greatly improving the query speed.

The ontology is constructed to key-value pairs and the key-value pairs are stored in a plurality of computing nodes, and matched elements are acquired from the key-value pairs according to the query conditions and the query objects. Since the key-pairs are independent of each other, matching-based searching can be performed. This prevents complex reasoning operations, and thus speeds up the query and reasoning. In addition, enlarging the ontology causes minor impacts on the query speed.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art may derive other accompanying drawings based on these accompanying drawings without any creative efforts.

FIG. 1 is a schematic diagram of an ontology described by an RDF;

FIG. 2 is a flowchart of an ontology-based query method according to an embodiment of the present disclosure;

FIG. 3 is a flowchart of an ontology-based query method according to another embodiment of the present disclosure;

FIGS. 4A-4C show a diagram for constructing key-value pairs and storing the constructed key-value pairs according to another embodiment of the present disclosure;

FIG. 5 is a schematic structural diagram of an ontology-based query apparatus according to an embodiment of the present disclosure;

FIG. 6 is a schematic structural diagram of a searching module according to an embodiment of the present disclosure;

FIG. 7 is a schematic structural diagram of a second acquiring module according to an embodiment of the present disclosure;

FIG. 8 is a schematic structural diagram of another second acquiring module according to an embodiment of the present disclosure; and

FIG. 9 is a schematic structural diagram of another ontology-based query apparatus according to an embodiment of the present disclosure.

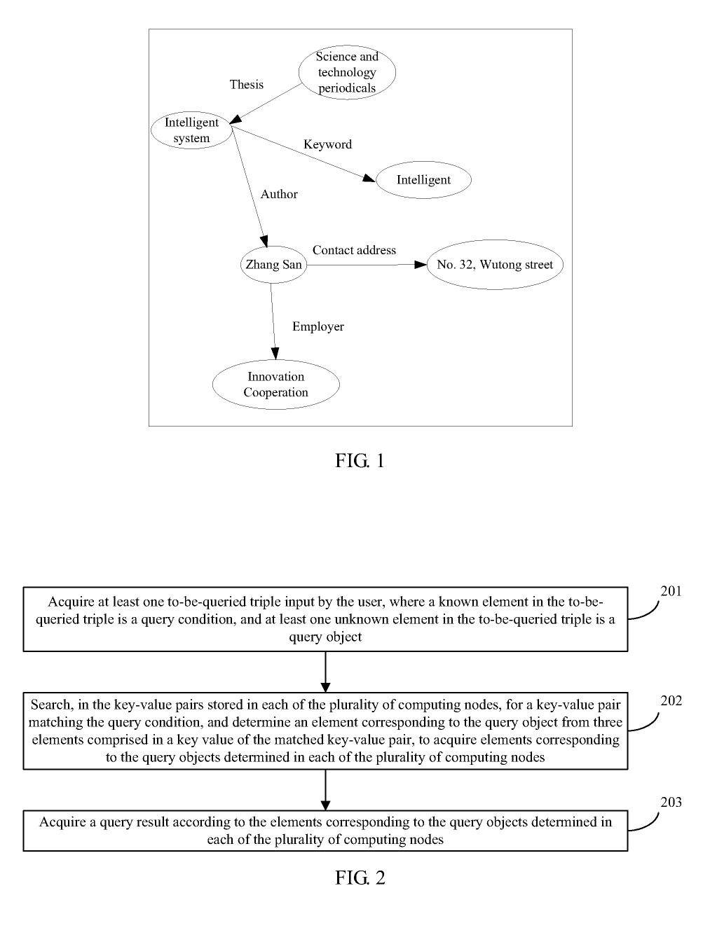

### DETAILED DESCRIPTION

To make the objectives, technical solutions, and advantages of the present disclosure clearer, embodiments of the present disclosure are described in detail below with reference to the accompanying drawings.

an ontology-based query method is provided in an embodiment of the present disclosure, where a plurality of key-value pairs constructed according to a triple of the ontology described with an RDF are stored in a plurality of computing nodes respectively, each of the plurality of key-value pairs including a key and a key value, the key value including three elements of the triple, and the key including one of the three elements of the triple. Referring to FIG. 2, the method includes the following steps:

201: Acquiring at least one to-be-queried triple input by the user, where a known element in the to-be-queried triple is a query condition, and at least one unknown element in the to-be-queried triple is a query object.

202: Searching, in the key-value pairs stored in each of the plurality of computing nodes, for at least one key-value pair matching the query condition, and determining an element corresponding to the query object from three elements comprised in a key value of the matched key-value pair, to acquire elements corresponding to the query objects determined in each of the plurality of computing nodes.

Specifically, if there is one known element in the to-be-queried triple, and the query condition is the one known element in the to-be-queried triple, the searching, in the key-value pairs stored in each of the plurality of computing nodes, for at least one key-value pair matching the query condition includes:

searching, in keys of the key-value pairs stored in each of the plurality of computing nodes, for at least one key matching a known element of the query condition, and using at least one key-value pair corresponding to the matched key as key-value pair matching the query condition.

Specifically, if there are two known elements in the to-be-queried triple, and the query condition is the two known elements in the to-be-queried triple, the searching, in the key-value pairs stored in each of the plurality of computing nodes, for at least one key-value pair matching the query condition includes:

searching, in keys of the key-value pairs stored in each of the plurality of computing nodes, for at least one key matching a known element of the query condition; and

searching, in key values corresponding to the matched key, for at least one key value matching another known element of the query condition, and using at least one key-value pair corresponding to the matched key value as key-value pair matching the query condition.

Specifically, if there are two known elements in the to-be-queried triple, and the query condition is the two known elements in the to-be-queried triple, the searching, in the key-value pairs stored in each of the plurality of computing nodes, for at least one key-value pair matching the query condition includes:

searching, in keys of the key-value pairs stored in each of the plurality of computing nodes, for at least one key matching a known element of the query condition and searching, in keys of the key-value pairs stored in each of the plurality of computing nodes, for at least one key matching another known element of the query condition, and using at least one key-value pair corresponding to the at least one key matching the one known element and at least one key-value pair corresponding to the at least one keys matching the another known element as key-value pair matching the query condition.

203: acquiring a query result according to the elements corresponding to the query objects determined in each of the plurality of computing nodes.

Specifically, the acquiring a query result according to the elements corresponding to the query objects determined in each of the plurality of computing nodes includes:

combining the elements corresponding to the query objects determined in each of the plurality of computing nodes to acquire the query result.

Specifically, the acquiring a query result according to the elements corresponding to the query objects determined in each of the plurality of computing nodes includes:

categorizing the elements corresponding to the query objects determined in each of the plurality of computing nodes according to the known elements of the query conditions to acquire elements corresponding to the query objects acquired according to each of the known elements of the query conditions; and

taking an intersection of the elements corresponding to the query objects acquired according to each of the known elements of the query conditions to acquire the query result.

Specifically, if there are a plurality of triples, the acquiring a query result according to the elements corresponding to the query objects determined in each of the plurality of computing nodes includes:

acquiring the query result according to a relation between each two of the plurality of to-be-queried triples, and the elements corresponding to the query objects determined in each of the plurality of computing nodes for each of the plurality of to-be-queried triples.

Specifically, the acquiring the query result according to a relation between each two of the plurality of to-be-queried triples and the elements corresponding to the query objects determined in each of the plurality of computing nodes for each of the plurality of to-be-queried triples includes:

if the relation between each two of the plurality of to-be-queried triples is an AND relation, taking an intersection of the elements corresponding to the query objects determined in each of the plurality of computing nodes for each of the plurality of to-be-queried triples to acquire the query result; and

if the relation between each two of the plurality of to-be-queried triples is an OR relation, taking a union of the elements corresponding to the query objects determined in each of the plurality of computing nodes for each of the plurality of to-be-queried triples to acquire the query result.

Furthermore, the method further includes:

constructing the plurality of key-value pairs according to the ontology described by the RDF, and storing the constructed plurality of key-value pairs in the plurality of computing nodes.

Specifically, the storing the constructed plurality of key-value pairs in the plurality of computing nodes includes:

if there are at least two key-value pairs, whose keys and corresponding key values are the same, in the constructed plurality of key-value pairs, storing at least one of the at least two key-value pairs in the plurality of computing nodes.

Specifically, the storing the constructed plurality of key-value pairs in the plurality of computing nodes includes:

storing key-value pairs of the constructed plurality of key-value pairs, whose key values are the same, in the same computing node.

According to the method provided in the embodiments of the present disclosure, the ontology described by an RDF is pre-constructed into a plurality of key-value pairs, and the key-value pairs are stored in a plurality of computing nodes. When a user performs a query operation, the user searches, in the key-value pairs stored in each of the plurality of computing nodes, for at least one key-value pair matching the query condition, determines an element corresponding to the query object from three elements comprised in a key value of the matched key-value pair, and acquires a query result according to the determined elements. In this way, a novel manner for storing the ontology described by the RDF is provided. Furthermore, since the stored key-value pairs are independent of each other, matched key-value pairs may be searched in the stored key-value pairs directly according to the query condition to acquire a query result. This prevents complex reasoning operations, and thus the query speed is improved. In addition, enlarging the ontology described by the RDF causes minor impacts on the query speed. Furthermore, since the key-value pairs are stored in the plurality of computing nodes, the searching may be performed in the plurality of computing nodes in parallel, thereby greatly improving the query speed.

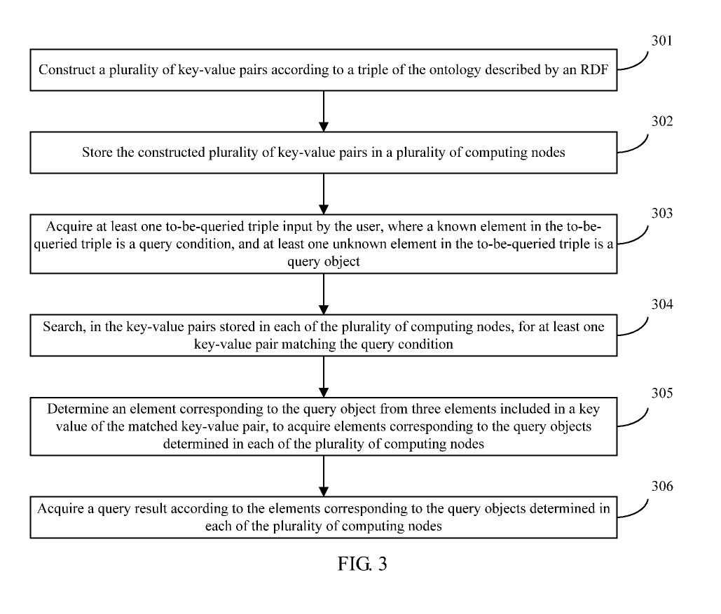

To improve the speed of querying user's desired data in the ontology described by an RDF, an embodiment of the present disclosure provides an ontology-based query method. With reference to the description in the above-described method embodiment, referring to FIG. 3, the method provided in this embodiment includes the following steps:

301: constructing a plurality of key-value pairs according to a triple of the ontology described by an RDF.

In this step, the ontology described by the RDF may be in a form of one or a plurality of RDF graphs, where each RDF graph corresponds to an RDF format file. The ontology described by the RDF includes at least one triple, where each triple includes three elements, i.e., subject, predicate, and object. For implementation of subsequent query operations, in this step, the constructing the triple of the ontology described by the RDF into key-value pairs specifically includes: setting each of the elements in the triple of the ontology described by the RDF to a key, setting the three elements of the triple as a key value corresponding to the key, and using the key and the key value as a key-value pair. The triple of the ontology described by the RDF may be acquired by reasoning based on a corresponding logical relation in the ontology. Each of the constructed plurality of key-value pairs includes a key and a key value, where the key value includes three elements of the triple, and the key includes one of the three elements of the triple.

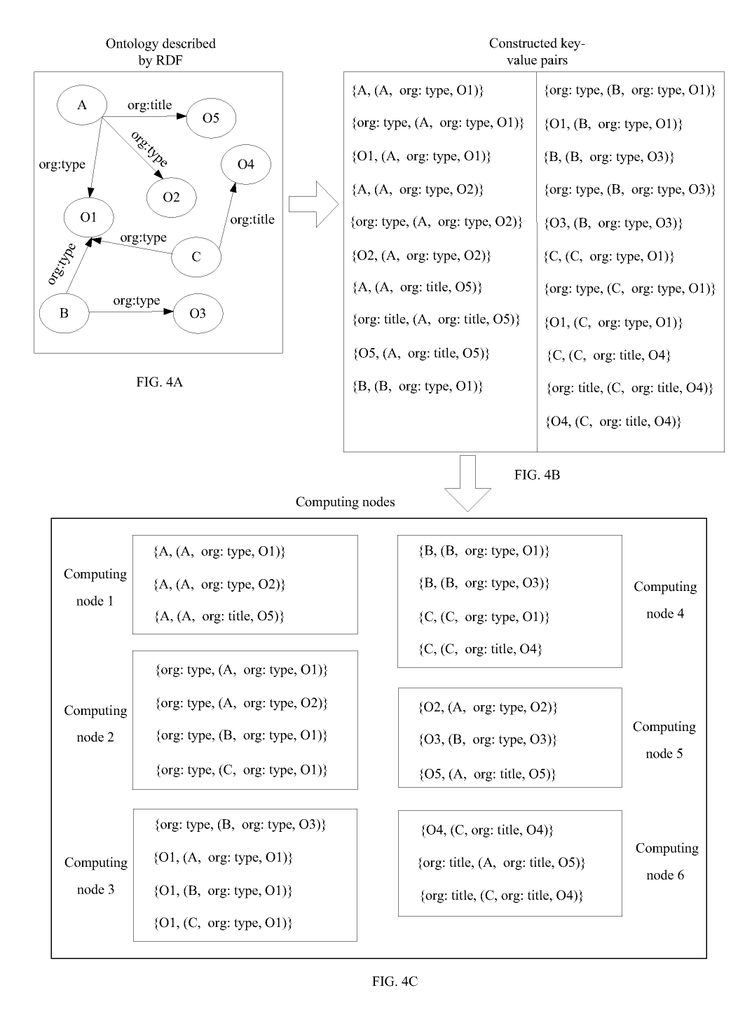

For example, using the ontology described by an RDF as illustrated in FIG. 4A as an example, triple

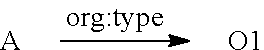

is acquired by reasoning according to a corresponding logical relation in the ontology described by the RDF, where element A is set to a key, the three elements (A, org:type, O1) in the triple corresponding to element A are set to key values corresponding to element A, and key A and key value (A, org:type, O1) are set to a key-value pair {A, (A, org:type, O1)}. Key-value pairs are constructed for each of the triples in the ontology described with the RDF according to the above-described method, and the constructed plurality of key-value pairs are as illustrated in FIG. 4B.

302: storing the constructed plurality of key-value pairs in a plurality of computing nodes.

After the plurality of key-value pairs are constructed, since no logical correlation exists between the plurality of key-value pairs, the constructed plurality of key-value pairs may be stored in the plurality of computing nodes for subsequent query. Each of the plurality of computing nodes has a specific storage space for storing the constructed plurality of key-value pairs. Since the key-value pairs occupy only a small storage space, and each key-value pair occupies substantially the same size of storage space, during storage, the computing node may assign a fixed storage space for each key-value pair. When the size of the storage space of a computing node store is fixed, the number of key-value pairs that can be stored in the computing node is also fixed. For example, when the size of the storage space of a computing node is 200 MB, and each key-value pair is assigned a 0.02 MB fixed storage space, the computing node is capable of storing 10000 key-value pairs. The number of computing nodes where the constructed plurality of key-value pairs are stored may be determined according to the number of constructed plurality of key-value pairs and the storage space and processing speed of each computing node, for example, four or five computing nodes. The embodiments of the present disclosure set no limitation to the number of computing nodes. When the number of constructed plurality of key-value pairs is definite, the more the computing nodes are, the higher the subsequent query speed is. Moreover, use of computing nodes having a higher processing speed may also improve the subsequent query speed.

Specifically, the manner of storing the constructed plurality of key-value pairs in the plurality of computing nodes includes, but is not limited to:

Manner 1: If there are at least two key-value pairs, whose keys and corresponding key values are the same, in the constructed plurality of key-value pairs, storing at least one of the at least two key-value pairs in the plurality of computing nodes.

After the plurality of key-value pairs are constructed in step 301 according to the plurality of triples of the ontology described by the RDF, since the plurality of triples of the ontology described the RDF may include a triple with the three elements contained herein being the same, the constructed plurality of key-value pairs may include at least two key-value pairs whose keys and corresponding keys are the same. To save the storage space of the computing nodes, one of the at least two key-value pairs whose keys and corresponding keys are the same may be stored in the plurality of computing nodes, and the other key-value pair(s) may be abandoned.

For example, after the key-value pairs are constructed according to step 301, if the constructed plurality of key-value pairs include two key-value pairs “pair 1={A, (A, org:type, O1)}, pair 2={A, (A, org:type, O1)}”, where key A and key value “(A, org:type, O1)” of pair 1 are the same as key A and key value “(A, org:type, O1)” of pair 2. Therefore, pair 1 is stored in the computing node.

Manner 2: storing key-value pairs of the constructed plurality of key-value pairs, whose key values are the same, in the same computing node.

In this manner, since in the ontology described by the RDF, the subject/object/predicate of a triple may be the subject/object/predicate of another triple, regardless of a key-value pair constructed according to the ontology described by an RDF or a key-value pair constructed according to the ontology described by a plurality of RDFs, the constructed plurality of key-value pairs may include key-value pairs whose keys are the same.

To improve the subsequent query speed, according to the method provided in this embodiment, during storing of the constructed plurality of key-value pairs, the key-value pairs whose keys are the same are stored in the same computing node. Specifically, the key-value pairs whose keys are the same are stored in the same computing node according to the number of key-value pairs that can be stored in each of the plurality of computing nodes and the number of the key-value pairs whose keys are the same in constructed plurality of key-value pairs. When the number of key-value pairs, in addition to the stored key-value pairs, that can be stored in each of the plurality of computing nodes is smaller than the number of non-stored key-value pairs whose keys are the same, a computing node is selected from the plurality of computing nodes, the non-stored key-value pairs whose keys are the same are stored in the selected computing node according to the number of key-value pairs that can be stored in the selected computing node, and the remaining key-value pairs whose keys are the same are stored in another computing node so that all the remaining key-value pairs whose keys are the same are stored in the computing node. Nevertheless, if the key of a key-value pair is different from that of any other key-value pair, the key-value pair may be stored in any of the plurality of computing nodes.

The key-value pairs whose keys are the same are stored in the same computing node, such that the number of different keys of the key-value pairs stored in each of the plurality of computing nodes is smaller. In this way, during subsequent searching for the key-value pair according to matching of the key, a corresponding key may be acquired by performing a few times of matching in each of the plurality of computing nodes, such that a key-value pair corresponding to the key is acquired.

It should be noted that, when the constructed plurality of key-value pairs are respectively stored in the plurality of computing nodes, the storing may be performed by using above manner 1 or manner 2, and preferably by using a combination of above manner 1 and manner 2.

For example, after the plurality of key-value pairs are constructed in step 301, the constructed plurality of key-value pairs as illustrated in FIG. 4B are respectively stored in six computing nodes, and the six computing nodes are computing nodes 1 to 6, where the corresponding numbers of key-value pairs that can be stored in the computing nodes are 3, 4, 4, 4, 3, and 3. If the number of key-value pairs having the same key A is 3, the computing node 1 capable of storing three key-value pairs is selected from the computing nodes 1 to 6, the three key-value pairs having the same key A are stored in the computing node 1, and it is calculated again that the number of key-value pairs, in addition to the stored key-value pairs, that can be stored in the computing node 1 is 0. If the number of key-value pairs having the same key “org:type” is 5, since the computing nodes 1 to 6 are incapable of storing all the five key-value pairs, other key-value pairs having the save key are preferably stored in the same computing node. Subsequently, if the computing node 2 is capable of additionally storing another four key-value pairs, the computing node 3 is capable of additionally storing another one key-value pair, and the other computing nodes are incapable of storing any key-value pair, four of the five key-value pairs having the same key “org:type” are stored in the computing node 2, and the remaining one key-value pairs having the same key “org:type” is stored in the computing node 3. After the constructed plurality of key-value pairs as illustrated in FIG. 4B are stored in the plurality of computing nodes, the key-value pairs stored in each of the plurality of computing nodes are as illustrated in FIG. 4C.

In addition to the above two manners, another manner may also be used for storing of the key-value pairs. For example, the constructed plurality of key-value pairs are randomly stored in each of the plurality of computing nodes. The embodiments of the present disclosure sets no limitation to the manner in which the constructed plurality of key-value pairs are stored in the plurality of computing nodes.

It should be noted that, after a plurality of key-value pairs are constructed according to a triple of the ontology described by an RDF, and the constructed plurality of key-value pairs are stored in a plurality of computing nodes, if a triple of the ontology described by a new RDF needs to be added to the plurality of computing nodes, steps 301 to 302 are performed again to store a plurality of key-value pairs constructed according to the triple of the ontology described by the new RDF to the plurality of computing nodes.

Based on steps 301 to 302, according to the embodiments of the present disclosure, a triple query operation may be performed in the plurality of computing nodes storing the key-value pairs. For details, reference may be made to steps 303 to 306.

303: acquiring at least one to-be-queried triple input by the user, where a known element in the to-be-queried triple is a query condition, and at least one unknown element in the to-be-queried triple is a query object.

With respect to this step, during a query based on the ontology described by an RDF, a user generally inputs a to-be-queried triple for query. The to-be-queried triple includes at least one known element for identifying a condition that the user expects the query result to satisfy. In addition, the to-be-queried triple further includes at least one unknown element, where the unknown element may be at least one of the subject, predicate, and the object in the triple, and at least one of the unknown elements may be used as a query object.

When the to-be-queried triple includes two known elements and one unknown element, the query condition may be the two known elements in the to-be-queried triple, and the query object is the one unknown element in the to-be-queried triple. When the to-be-queried triple includes one known element and two unknown elements, the query condition may be the one known element in the to-be-queried triple, and the query condition may be the two unknown elements in the to-be-queried triple or may be any one of the two unknown elements in the to-be-queried triple. For example, if the to-be-queried triple is “(?s, org:type, ?o)”, the query condition is one known element, i.e., predicate “org:type”, in the to-be-queried triple; and the query object may be two unknown elements, i.e., subject “s” and object “o”, in the to-be-queried triple, or may be any one, i.e., subject “s” or object “o”, of the two unknown elements in the to-be-queried triple. If the query object is the two unknown elements, i.e., subject “s” and object “o”, the user expects to query subject “s” and object “o” satisfying the query condition of predicate “org:type”. When the query object is the one unknown element, i.e., subject “s”, the user expects to query subject “s” satisfying the query condition of predicate “org:type”.

Specifically, during acquiring of at least one to-be-queried triple input by the user, the user needs to input the triple in a machine-identifiable language. Since query is performed based on the ontology described by an RDF according to the embodiments of the present disclosure, the to-be-queried triple is acquired according to a query sentence input in a query language of the ontology described by the RDF employed by the user. A plurality of query languages of the ontology described by the RDF may be employed. The Simple Protocol and RDF Query Language (SPARQL) is a commonly used query language, and the SPARQL is also a standardized query language. Other query languages, for example, Structured Query Language (SQL) and the like, may be acquired by analogy using SPARQL. Therefore, the embodiments of the present disclosure are described by using the query language SPARQL as an example. When the query language SPARQL is used, an SPARQL query sentence needs to be firstly acquired, where the format of the query sentence is “select ?s where(?s, p, ?o)”; and the to-be-queried triple may be acquired according to the sentence input by the user. In the format, “where(?s, p, o)” indicates that the query condition is the known elements predicate “p” and subject “o” in the to-be-queried triple, and “select ?s” indicates that the query object is the unknown element subject “s” in the to-be-queried triple.

Nevertheless, the user may not need to input a complete SPARQL query sentence, but may input a query keyword, for example, “p” and “o”, and it is understood using the query understanding technology that semantics of the query keyword input by the user is that the user expects to query a subject with predicate “p” and object “o”. Subsequently, the user constructs the SPARQL query sentence according to the understanding to determine the to-be-queried triple, or directly determines the to-be-queried triple according to the semantic understanding. Using the query understanding technology, a semantic relation between query keywords may be understood. For example, when the user inputs keywords “author” and “ISMIS”, it may be determined using the query understanding technology that the user expects to search for the author of the article ISMIS, and the SPARQL query sentence “select ?o where (ISMIS, author, ?o)” may be constructed, such that the to-be-queried triple “(ISMIS, author, ?o)” is acquired according to the constructed SPARQL query sentence. The applied query understanding technology is the same as the conventional query understanding technology. For details, reference may be made to the document Effective and Efficient Keyword Query Interpretation Using a Hybrid Graph released on the Web Information System Engineering (WISE) international conference, which are not described herein any further.

When the user expects to query a result satisfying more conditions, the user may input a more complex SPARQL query sentence according to grammar of the SPARQL query language, and may acquire a plurality of to-be-queried triples according to the input SPARQL query sentence. The plurality of to-be-queried triples has a specific relation therebetween. An AND relation, an OR relation, or other relations may exist between the plurality of to-be-queried triples. The AND relation refers to querying a result satisfying each of the plurality of to-be-queried triples; and the OR relation refers to querying a result satisfying one of the plurality of to-be-queried triples. Different relation identifiers may be assigned to the different relations between the plurality of to-be-queried triples. The relation identifier may be a text identifier, a number identifier, and the like. According to the relation identifiers, the relations between the plurality of to-be-queried triples may be determined.

For example, when the user inputs the SPARQL query sentence “select ?s where{(?s, p1, ?o1), and (?s, p2, o2)}”, two to-be-queried triples may be acquired according to the input SPARQL query sentence. The to-be-queried triple 1 is “(?s, p1, ?o1)”, where the query condition is the known element predicate “p1” in the to-be-queried triple, and the query object is the unknown element subject “s” in the to-be-queried triple. The to-be-queried triple 2 is “(?s, p2, o2)”, where the query condition is the known elements predicate “p2” and object “o2” in the to-be-queried triple, and the query object is the unknown element subject “s” in the to-be-queried triple. In addition, it is determined, according to the relation identifier “and”, that the to-be-queried triple 1 is in an AND relation with the to-be-queried triple 2. That is, the query result needs to satisfy both the to-be-queried triple 1 and the to-be-queried triple 2. Still for example, when the user inputs the SPARQL query sentence “select ?s where {(?s, p1, ?o), or (?s, p2, o2)}”, the to-be-queried triple 1 and the to-be-queried triple 2 may also be acquired according to the input SPARQL query sentence. In addition, it is determined, according to the relation identifier “or”, that the to-be-queried triple 1 is in an OR relation with the to-be-queried triple 2. That is, the query result needs to satisfy either the to-be-queried triple 1 or to-be-queried triple 2.

For example, still using the case where the computing nodes 1 to 6 store the key-value pairs as illustrated in FIG. 4C as an example, the two to-be-queried triples may be acquired according to the SPARQL query sentence “select ?s where {(?s, org:type, O1), and (?s, org:title, ?o)}” input by the user. The to-be-queried triple 1 is “(?s, org:type, O1)”, where the query condition is the known elements predicate “org:type” and object “O1” in the to-be-queried triple, and the query object is the unknown element subject “s” in the to-be-queried triple. The to-be-queried triple 2 is “(?s, org:title, ?o)”, where the query condition is the known element predicate “org:title” in the to-be-queried triple, and the query object is the unknown element subject “s” in the to-be-queried triple. In addition, it is determined, according to the relation identifier “and”, that the to-be-queried triple 1 is in an AND relation with the to-be-queried triple 2. That is, the query result needs to satisfy both the to-be-queried triple 1 and the to-be-queried triple 2.

304: searching, in the key-value pairs stored in each of the plurality of computing nodes, for at least one key-value pair matching the query condition.

With respect to this step, the searching, in the key-value pairs stored in each of the plurality of computing nodes, for at least one key-value pair matching the query condition may be sequentially performed in the key-value pairs stored in the plurality of computing nodes. Preferably, to save the searching time, the searching may be performed concurrently in the key-value pairs stored in the plurality of computing nodes. The embodiments set no limitation to the manner for searching in the plurality of computing nodes.

Key-value pairs stored in a computer are constructed by keys and corresponding key values thereof, each element in a triple may be respectively a key, and the three elements in the triple may serve as key value. Therefore, by searching, in keys of the key-value pairs stored in each of the plurality of computing nodes, for at least one key matching a known element, the key-value pair including the known element may be acquired. In addition, during storing the constructed plurality of key-value pairs in the plurality of computing nodes, key-value pairs whose keys are the same are stored in the same computing node such that the number of different keys of the key-value pairs stored in each of the plurality of computing nodes is smaller. In each of the computing nodes, different keys of the key-value pairs stored in the computing node may be identified to search, in the different identified keys, for a key matching a known element of the query condition, with no need of searching, in all keys corresponding to each of the key-value pairs stored in each of the plurality of computing nodes, a key matching the query condition.

Specifically, the manner of searching, in the key-value pairs stored in each of the plurality of computing nodes, for at least one key pair matching the query condition varies with the number of known element in the query condition, which includes, but is not limited to:

Manner 1: If there is one known element in the to-be-queried triple, and the query condition is the one known element in the to-be-queried triple, searching is performed, in keys of the key-value pairs stored in each of the plurality of computing nodes, for at least one key matching a known element of the query condition, and at least one key value pair corresponding to the matched key is used as key-value pair matching the query condition.

When the query condition includes a known element, at least one key matching the known element is searched in keys of the key-value pairs stored in each of the plurality of computing nodes. Since no other known element is included in the query condition, a key-value pair matching the searched matched key is a key-value pair matching the query condition.

For example, the query condition of the to-be-queried triple 2 is a known element predicate “org:title”, after the searching is performed in the computing nodes 1 to 6 in the above-described manner, no key-value pair matching the known element predicate “org:title” is searched out in the computing nodes 1 to 5, but key “org:type” matching the known element predicate “org:title” is searched out in the computing node 6. In this case, the key-value pairs “{org:title, (A, org:title, O5)}” and “{org:title, (C, org:title, O4)}” corresponding to the matched key “org:title” are used as key-value pairs matching the query condition.

Manner 2: If there are two known elements in the to-be-queried triple, and the query condition is the two known elements in the to-be-queried triple, searching is performed, in keys of the key-value pairs stored in each of the plurality of computing nodes, for at least one key matching a known element of the query condition; and searching is performed, in key values corresponding to the matched key, for at least one key value matching another known element of the query condition, and a key-value pair corresponding to the matched key value is used as a key-value pair matching the query condition.

During searching, in keys of the key-value pairs stored in each of the plurality of computing nodes, for at least one key matching a known element of the query condition, a key matching any one of two known elements in the triple may be searched in keys of the key-value pairs stored in each of the plurality of computing nodes. During searching, in the key values corresponding to the matched key, for at least one key value matching another known element included in the query condition, specifically according to the position of the another known element in the triple, key values matching the other known elements may be searched in the key values corresponding to the matched key according to the positions of the other known elements in the triple, and the key value pair corresponding to the matched key value is used as a key-value pair matching the query condition.

For example, the to-be-queried triple 1 includes two known elements, and the query condition is the two known elements predicate “org:type” and object “O1”. Search is performed in the keys of the key-value pairs stored in the computing node 1 for a key matching one known element predicate “org:type” of the query condition, and no key matching one known element predicate “org:type” of the query condition is searched out. Search is performed in the keys of the key-value pairs stored in the computing node 2 for a key matching one known element predicate “org:type” of the query condition, and key “org:type” matching the known element predicate “org:type” of the query condition is searched out in the keys of the key-value pairs stored in the computing node 2. Key values matching another known element O1 of the query condition are searched in key values “(A, org: type, O1), (A, org: type, O2), (B, org: type, O1), and (C, org: type, O1) corresponding to the matched key “org: type”. The elements in the object position in key values (A, org: type, O1), (B, org: type, O1), and (C, org: type, O1) match the known element object “O1”, and key-value pairs “{org: type, (A, org: type, O1)}”, “{org: type, (B, org: type, O1)}”, and “{org: type, (C, org: type, O1)}” corresponding to the matched key values are used as key-value pairs matching the query condition of the to-be-queried triple 1. Likewise, Search is also performed in the computing nodes 3 to 6 and no key-value pair matching the query condition of the to-be-queried triple 1 is searched out.

Manner 3: If there are two known elements in the to-be-queried triple, and the query condition is the two known elements in the to-be-queried triple, searching is performed, in keys of the key-value pairs stored in each of the plurality of computing nodes, for at least one key matching a known element of the query condition and searching is performed, in keys of the key-value pairs stored in each of the plurality of computing nodes, for at least one key matching another known element of the query condition, and key-value pairs corresponding to the key(s) matching the one known element and key-value pairs corresponding to the keys matching the another known element are used as key-value pairs matching the query condition.

In this manner, key-value pairs corresponding to the key values matching any of the known elements of the query condition are all used as key-value pairs matching the query condition. In this case, the acquired matched key-value pairs may not all match two known elements of the query condition. Nevertheless, in subsequent steps, according to the matched key-value pairs, the elements matching the two known elements of the query condition may be determined.

For example, the to-be-queried triple 1 includes two known elements, and the query condition is the two known elements predicate “org:type” and object “O1”. Search is performed in the keys of the key-value pairs stored in the computing node 1 for a key matching the known element predicate “org:type” of the query condition, and no key matching the known element predicate “org:type” of the query condition is searched out; and search is performed in the keys of the key-value pairs stored in the computing node 1 for a key matching the known element object “O1”, and no key matching the known element object “O1” is searched out. Likewise, keys matching predicate “org:type” are searched out in the keys of the key-value pairs stored in the computing node 2, but no key matching the object “O1” is searched out therein. In this case, key-value pairs “{org:type, (A, org:type, O1)}”, “{org:type, (B, org:type, O1)}”, and “{org:type, (C, org:type, O1)}” corresponding to the keys matching predicate “org:type” are used as key-value pairs matching the query condition of the to-be-queried triple 1. Key “org:type” matching predicate “org:type” is searched out in the keys of the key-value pairs stored in the computing node 3, and key “O1” matching object “O1” is also searched out therein. In this case, key-value pair “{org:type, (B, org:type, O3)}” corresponding to key “org:type” matching predicate “org:type”, and key-value pairs “{O1, (A, org:type, O1)}”, “{O1, (B, org:type, O1)}”, and “{O1, (C, org:type, O1)}” corresponding to key “O1” matching object “O1” are all used as key-value pairs matching the query condition of the to-be-queried triple 1. No key matching predicate “org:type” is searched out in the computing nodes 4 to 6, and no key matching object “O1” is searched out therein.

In addition to the above-described manner 1, manner 2, and manner 3, other manners may also be used for searching, in the key-value pairs stored in each of the plurality of computing nodes, for a key-value pair matching the query condition. The embodiments of the present disclosure set no limitation to the specific manner for searching, in the key-value pairs stored in each of the plurality of computing nodes, for a key-value pair matching the query condition.

305: determining an element corresponding to the query object from three elements included in a key value of the matched key-value pair, to acquire elements corresponding to the query objects determined in each of the plurality of computing nodes.

With respect to this step, since the query object is an unknown element in the to-be-queried triple and the key value in the matched key-value pair includes three elements in the triple, the element corresponding to the query object may be determined from the searched key value in the matched key-value pair. With respect to each of the plurality of computing nodes, the element corresponding to the query object may be determined from three elements included in the key value of the matched key-value pair, thereby acquiring elements corresponding to the query objects determined in each of the plurality of computing nodes. Specifically, the element corresponding to a position of the unknown element of the query object in the triple acquired from the three elements included in the key value of matched key-value pair is used as the element corresponding to the query object.

In addition, the searched matched key-value pair also varies according to manners of searching the key-value pair that matches the query condition from the key-value pair stored in each of the plurality of computing node in step 304. Therefore, elements corresponding to the query object determined in the searched matched key-value pair are also different.

For example, with respect to to-be-queried triple 1, after the key value that matches the query condition is searched from the key-value pair stored in each of the plurality of computing nodes by using manner 2 in step 304, elements “[A, B, C]” corresponding to query object subject “s” are determined from three elements “(A, org:type, O1)”, “(B, org:type, O1)”, and “(C, org:type, O1)” included in the searched key value of the matched key-value pair in a computing node 2, and elements “[A, B, C]” determined in the computing node 2 are acquired.

With respect to to-be-queried triple 1, after the key value that matches the query condition is searched from the key-value pair stored in each of the plurality of computing nodes by using manner 3 in step 304, elements “[A, B, C]” corresponding to the query object subject “s” are determined from key values “(A, org:type, O1)”, “(B, org:type, O1)”, and “(C, org:type, O1)” of the searched key-value pair that matches the known element predicate “org:type” in the computing node 2. Element [B] corresponding to the query object subject “s” is determined from key value “(B, org:type, O3)” of the searched key-value pair that matches the known element predicate “org:type” in the computing node 3. Elements [A, B, C] corresponding to the subject “s” are determined from key values “(A, org:type, O1)”, “(B, org:type, O1)”, and “(C, org:type, O1)” of the searched key-value pair that matches known element object “O1” in the computing node 3.

With respect to to-be-queried triple 2, after the key value that matches the query condition is searched from the key-value pair stored in each of the plurality of computing nodes by using manner 1 in step 304, elements “[A, C]” corresponding to query object subject “s” are determined from three elements “(A, org:title, O5)” and “(C, org:title, O4)” included in the key value of the searched matched key-value pair in a computing node 6, and elements “[A, C]” determined in the computing node 6 are acquired.

306: acquiring a query result according to the elements corresponding to the query objects determined in each of the plurality of computing nodes.

With respect to this step, a manner for acquiring the query result according to the elements corresponding to the query objects determined in each of the plurality of computing nodes varies with the manner for searching the key-value pair that matches the query condition from the key-value pairs stored in each of the plurality of computing nodes in step 304. When the number of the to-be-queries triples is 1, specifically, the following two manners are included:

Manner 1: If manner 1 or manner 2 is used to search the key-value pair that matches the query condition from the key-value pairs stored in the plurality of computing nodes in step 304, in this step, the elements corresponding to the query objects determined in each of the plurality of computing nodes are combined, to acquire the query result.

In this manner, when the matched key-value pair is searched out in any computing node according to the query condition, the element corresponding to the query object may be determined in the computing node; when the matched key-value pair is not searched in any computing node according to the query condition, the element corresponding to the query object determined in the computing node is zero. Therefore, when the query result is determined, the elements corresponding to the query objects determined in each of the plurality of computing nodes are combined to acquire the query result.

For example, if the to-be-queried triple acquired in step 302 is only to-be-queried triple 1, the key-value pair that matches the query condition is searched out from the key-value pairs stored in the plurality of computing nodes by using manner 2 in step 304; after the elements determined in each of the plurality of computing nodes are acquired in step 305, if the element corresponding to the query object determined in the computing node 2 is “[A, B, C]” and no determined element exists in the computing node 1, and the computing nodes 3 to 6, the elements determined in the computing node 1 to the computing node 6 are combined to acquire the query result “[A, B, C]”.

Manner 2: If manner 3 is used to search the key-value pair that matches the query condition from the key-value pairs stored in each of the plurality of computing nodes in step 304, in this step, the elements corresponding to the query objects determined in each of the plurality of computing nodes according to the known elements of the query conditions are categorized to acquire the elements corresponding to the query objects acquired according to each of the known elements of the query conditions; an intersection of the elements corresponding to the query objects acquired according to each of the known elements of the query conditions is taken to acquire the query result.

For this manner, because key-value pairs corresponding to the keys matching the one known element and key-value pairs corresponding to the keys matching the another known element are used as key-value pairs matching the query condition when manner 3 is used to search the key-value pair that matches the query condition from the key-value pairs stored in the plurality of computing nodes in step 304, the elements corresponding to the query objects determined in step 305 are only elements satisfying either one of the known element and another known element of the query condition. However, the query result is required to satisfy both of the two known elements in the query condition, the element corresponding to each known element of the query condition needs to be acquired in each of the plurality of computing nodes first, and the intersection of the elements corresponding to the query objects acquired according to each of the known elements of the query conditions is taken. The elements in the intersection are the elements corresponding to the query objects that satisfy two known elements of the query conditions.

For example, if the to-be-queried triple acquired in step 302 is only the to-be-queried triple 1, after manner 3 is used to search the key-value pair that matches the query condition from the key-value pairs stored in each of the plurality of computing nodes in step 304 and the elements corresponding to the query objects determined in each of the plurality of computing nodes are acquired in step 305, the elements corresponding to the query objects determined in each of the plurality of computing nodes according to the known elements of the query conditions are categorized to acquire the elements corresponding to the query objects acquired according to each of the known elements of the query conditions; the elements “[A, B, C, B]” corresponding to the query objects corresponding to the known element predicate “org:type” of the query condition in the computing nodes 1 to 6 are acquired, and the elements “[A, B, C]” corresponding to the known element object “O1” of the query condition in the computing nodes 1 to 6 are acquired; the intersection of the elements corresponding to the query objects acquired according to each of the known elements of the query conditions is taken, to acquire the query result “[A, B, C]”.

It should be noted that, when there are a plurality of to-be-queried triples acquired in step 303, the query result is acquired according to the elements corresponding to the query objects determined in each of the plurality of computing nodes, including acquiring the query result according to a relation between the plurality of to-be-queried triples, and the elements corresponding to the query objects determined in each of the plurality of computing nodes for each of the plurality of to-be-queried triples.

Specifically, if the relation between each two of the plurality of to-be-queried triples is an AND relation, an intersection of the elements corresponding to the query objects determined in each of the plurality of computing nodes for each of the plurality of to-be-queried triples is taken to acquire the query result; and if the relation between each two of the plurality of to-be-queried triples is an OR relation, a union of the elements corresponding to the query objects determined in each of the plurality of computing nodes for each of the plurality of to-be-queried triples is taken to acquire the query result.

If the relation between each two of the plurality of to-be-queried triples is an AND relation, the query results shall meet each to-be-queried triple among the plurality of to-be-queried triples. However, the same elements among the elements corresponding to the query objects determined in each of the plurality of computing nodes for each of the plurality of to-be-queried triples can satisfy each to-be-queried triple among the plurality of to-be-queried triples. Therefore, the intersection of the elements corresponding to the query objects determined in each of the plurality of computing nodes for each of the plurality of to-be-queried triples needs to be taken to acquire the query result. If the relation between each two of the plurality of to-be-queried triples is an OR relation, the query results shall meet any one of the plurality of to-be-queried triples. However, the elements corresponding to the query objects determined in each of the plurality of computing nodes for each of the plurality of to-be-queried triples can satisfy one of the plurality of the to-be-queried triples. Therefore, the union of the elements corresponding to the query objects determined in each of the plurality of computing nodes for each of the plurality of to-be-queried triples needs to be taken to acquire the query result. Nevertheless, when the number of to-be-queried triples is three or more, the plurality of to-be-queried triples may include both AND relation and OR relation. Therefore, the query result is acquired from the elements corresponding to the query objects determined in each of the plurality of computing nodes for every two to-be-queried triples according to the relation between every two to-be-queried triples.

For example, the relation between the acquired to-be-queried triple 1 and to-be-queried triple 2 in step 302 is an AND relation, the elements corresponding to the query objects determined in computing node 1 to computing node 6 with respect to the triple 1 are “[A, B, C]”, and the elements corresponding to the query objects determined in computing node 1 to computing node 6 with respect to the triple 2 are “[A, C]”; the intersection of “[A, B, C]” and “[A, C]” is taken, and the query result “[A, C]” is acquired.

It should be noted that, after the ontology described by the RDF is constructed into a plurality of key-value pairs in step 301 to step 302 and the key-value pairs are stored in a plurality of computing nodes, step 303 to step 306 may be performed for a plurality of times according to a query requirement, to acquire the query result satisfying a user expectation.

In specific implementation, when the user expects to query data that satisfies a certain query condition from a database or a website, the to-be-queried triple may be acquired according to a query keyword input by the user, or the query result may be acquired by using the method provided by the embodiments of the present invention according to the to-be-queried triple directly input by the user. For example, if the user expects to query a contact address of Zhang San, to-be-queried triple (Zhang San, contact address, ?o) is input, the query condition is known element subject “Zhang San” and predicate “contact address” in the to-be-queried triple, and the query object is the unknown element object “o” in the to-be-queried triple. The element corresponding to the query object may be acquired by using the method provided by the embodiments of the present invention, and the acquired element corresponding to the query object is the element that satisfies the query condition of the user. After the acquired element corresponding to the query object is used as the query result, the query result may be returned to the user in a manner such as on a display, so that the user obtains a more accurate query result.

According to the method provided in the embodiments of the present disclosure, the ontology described by an RDF is pre-constructed into a plurality of key-value pairs, and the key-value pairs are stored in a plurality of computing nodes. When a user performs a query operation, the user searches, in the key-value pairs stored in each of the plurality of computing nodes, for a key-value pair matching the query condition, determines an element corresponding to the query object from three elements included in a key value of the matched key-value pair, and acquires a query result according to the determined elements. In this way, a novel manner for storing the ontology described by the RDF is provided. Furthermore, since the stored key-value pairs are independent of each other, matched key-value pairs may be searched in the stored key-value pairs directly according to the query condition to acquire a query result. This prevents complex reasoning operations, and thus the query speed is improved. In addition, enlarging the ontology described by the RDF causes minor impacts on the query speed. Furthermore, since the key-value pairs are stored in the plurality of computing nodes, the searching may be performed in the plurality of computing nodes in parallel, thereby greatly improving the query speed.

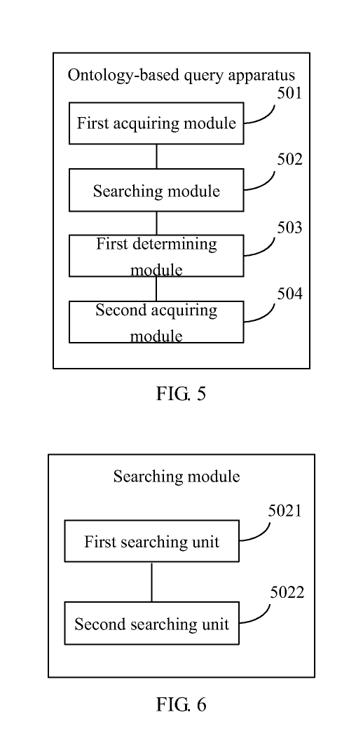

An embodiment of the present disclosure provides an ontology-based query apparatus, where the apparatus is configured to perform the method provided in the above-described method embodiments. A plurality of key-value pairs constructed according to a triple of the ontology described with an RDF are stored in a plurality of computing nodes respectively, each of the plurality of key-value pairs including a key and a key value, the key value comprising three elements of the triple, and the key including one of the three elements of the triple. Referring to FIG. 5, the apparatus includes:

a first acquiring module 501, configured to acquire at least one to-be-queried triple input by the user, where a known element in the to-be-queried triple is a query condition, and at least one unknown element in the to-be-queried triple is a query object;

a searching module 502, configured to search, in the key-value pairs stored in each of the plurality of computing nodes, for at least one key-value pair matching the query condition acquired by the first acquiring module 501;

a first determining module 503, configured to determine an element corresponding to the query object from three elements included in a key value of the matched key-value pair acquired by the searching module 502, to acquire elements corresponding to the query objects determined in each of the plurality of computing nodes; and

a second acquiring module 504, configured to acquire a query result according to the elements corresponding to the query objects determined by the first determining module 503 in each of the plurality of computing nodes.

Specifically, if there is one known element in the to-be-queried triple, and the query condition is the one known element in the to-be-queried triple, the searching module 502 is configured to search, in keys of the key-value pairs stored in each of the plurality of computing nodes, for at least one key matching a known element of the query condition, and use at least one key-value pair corresponding to the matched key as key-value pair matching the query condition.

Specifically, if there are two known elements in the to-be-queried triple, and the query condition is the two known elements in the to-be-queried triple, referring to FIG. 6, the searching module 502 includes:

a first searching unit 5021, configured to search, in keys of the key-value pairs stored in each of the plurality of computing nodes, for at least one key matching a known element of the query condition; and

a second searching unit 5022, configured to search, in key values corresponding to the matched key acquired by the first searching unit 5021, for at least one key value matching another known element of the query condition, and use at least one key-value pair corresponding to the matched key value as key-value pair matching the query condition.

Specifically, the second acquiring module 504 is configured to combine the elements corresponding to the query objects determined in each of the plurality of computing nodes to acquire the query result.

Specifically, if there are two known elements in the to-be-queried triple, and the query condition is the two known elements in the to-be-queried triple, the searching module 502 is configured to search, in keys of the key-value pairs stored in each of the plurality of computing nodes, for at least one key matching a known element of the query condition and search, in keys of the key-value pairs stored in each of the plurality of computing nodes, for at least one key matching another known element of the query condition, and use at least one key-value pair corresponding to the at least one key matching the one known element and at least one key-value pair corresponding to the at least one keys matching the another known element as key-value pair matching the query condition.

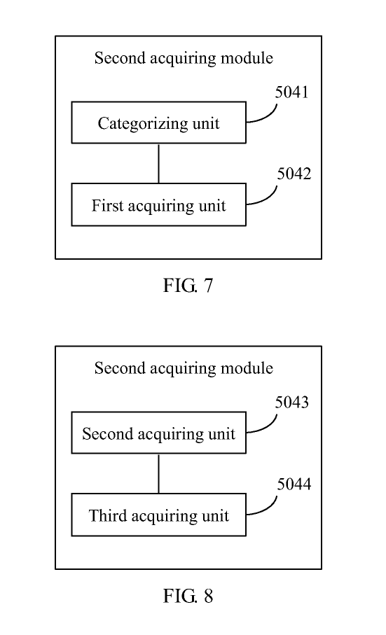

Specifically, referring to FIG. 7, the second acquiring module 504 includes:

a categorizing unit 5041, configured to categorize the elements corresponding to the query objects determined in each of the plurality of computing nodes according to the known elements of the query conditions to acquire elements corresponding to the query objects acquired according to each of the known elements of the query conditions; and

a first acquiring unit 5042, configured to take an intersection of the elements corresponding to the query objects acquired by the categorizing unit 5041 according to each of the known elements of the query conditions to acquire the query result.

Specifically, if there are a plurality of to-be-queried triples, the second acquiring module 504 is configured to acquire the query result according to a relation between each two of the plurality of to-be-queried triples and the elements corresponding to the query objects determined in each of the plurality of computing nodes for each of the plurality of to-be-queried triples.

Specifically, referring to FIG. 8, the second acquiring module 504 includes:

a second acquiring unit 5043, configured to: take an intersection of the elements corresponding to the query objects determined in each of the plurality of computing nodes for each of the plurality of to-be-queried triples to acquire the query result if the relation between each two of the plurality of to-be-queried triples is an AND relation; and

a third acquiring unit 5044, configured to: take a union of the elements corresponding to the query objects determined in each of the plurality of computing nodes for each of the plurality of to-be-queried triples to acquire the query result if the relation between each two of the plurality of to-be-queried triples is an OR relation.

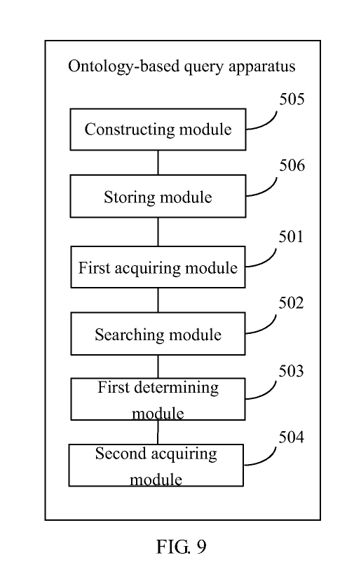

Furthermore, referring to FIG. 9, an apparatus further includes:

a constructing module 505, configured to construct a triple of the plurality of key-value pairs according to the ontology described by the RDF; and

a storing module 506, configured to store the plurality of key-value pairs constructed by the constructing module 505 in the plurality of computing nodes.

Specifically, the storing module 506 is configured to: if there are at least two key-value pairs, whose keys and corresponding key values are the same, in the constructed plurality of key-value pairs, store at least one of the at least two key-value pairs in the plurality of computing nodes.

Specifically, the storing module 506 is configured to: store key-value pairs of the constructed plurality of key-value pairs, whose key values are the same, in the same computing node.

According to the apparatus provided in the embodiments of the present disclosure, the ontology described by an RDF is pre-constructed into a plurality of key-value pairs, and the key-value pairs are stored in a plurality of computing nodes. When a user performs a query operation, the user searches, in the key-value pairs stored in each of the plurality of computing nodes, for a key-value pair matching the query condition, determines an element corresponding to the query object from three elements included in a key value of the matched key-value pair, and acquires a query result according to the determined elements. In this way, a novel manner for storing the ontology described by the RDF is provided. Furthermore, since the stored key-value pairs are independent of each other, matched key-value pairs may be searched in the stored key-value pairs directly according to the query condition to acquire a query result. This prevents complex reasoning operations, and thus the query speed is improved. In addition, enlarging the ontology described by the RDF causes minor impacts on the query speed. Furthermore, since the key-value pairs are stored in the plurality of computing nodes, the searching may be performed in the plurality of computing nodes in parallel, thereby greatly improving the query speed.

It should be noted that, during ontology-based query performed by the ontology-based query apparatus provided in the above-described embodiments, the apparatus is described by only using division of the above functional modules as an example. In practice, the functions may be assigned to different functional modules for implementation as required. To be specific, the internal structure of the ontology-based query apparatus is divided into different functional modules to implement all or part of the above-described functions. In addition, the ontology-based query apparatus and the ontology-based query method pertain to the same inventive concept, where the specific implementation is elaborated in the method embodiments, which is not be detailed herein any further.

The sequence numbers of the preceding embodiments of the present disclosure are only for ease of description, but do not denote the preference of the embodiments.

Persons of ordinary skill in the art should understand that all or part of steps of the preceding methods may be implemented by hardware or hardware following instructions of programs. The programs may be stored in a non-transitory computer-readable storage medium, and may be executed by at least one processor. The storage medium may be a read only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

What is claimed is:

1. An ontology-based query method, wherein a plurality of key-value pairs constructed according to a triple of an ontology described with a resource description framework (RDF) are stored in a plurality of computing nodes respectively, each of the plurality of key-value pairs comprising a key and a key value, the key value comprising three elements of the triple, and the key comprising one of the three elements of the triple, the method comprising:
acquiring at least one to-be-queried triple input by a user, wherein a known element in the to-be-queried triple is a query condition, and at least one unknown element in the to-be-queried triple is a query object;
searching, in the key-value pairs stored in each of the plurality of computing nodes, for at least one key-value pair matching the query condition;
determining an element corresponding to the query object from three elements comprised in a key value of the matched key-value pair, to acquire elements corresponding to the query objects determined in each of the plurality of computing nodes; and
acquiring a query result according to the elements corresponding to the query objects determined in each of the plurality of computing nodes.

2. The method according to claim 1, wherein there is one known element in the to-be-queried triple, and the query condition is the one known element in the to-be-queried triple, the searching, in the key-value pairs stored in each of the plurality of computing nodes, for at least one key-value pair matching the query condition comprises:
searching, in keys of the key-value pairs stored in each of the plurality of computing nodes, for at least one key matching a known element of the query condition; and
using at least one key-value pair corresponding to the matched key as key-value pair matching the query condition.

3. The method according to claim 2, wherein the acquiring a query result according to the elements corresponding to the query objects determined in each of the plurality of computing nodes comprises:
combining the elements corresponding to the query objects determined in each of the plurality of computing nodes to acquire the query result.

4. The method according to claim 1, wherein there are two known elements in the to-be-queried triple, and the query condition is the two known elements in the to-be-queried triple, the searching, in the key-value pairs stored in each of the plurality of computing nodes, for at least one key-value pair matching the query condition comprises:
searching, in keys of the key-value pairs stored in each of the plurality of computing nodes, for at least one key matching a known element of the query condition;
searching, in key values corresponding to the matched key, for at least one key value matching another known element of the query condition; and
using at least one key-value pair corresponding to the matched key value as key-value pair matching the query condition.

5. The method according to claim 1, wherein there are two known elements in the to-be-queried triple, and the query condition is the two known elements in the to-be-queried triple, the searching, in the key-value pairs stored in each of the plurality of computing nodes, for at least one key-value pair matching the query condition comprises:
searching, in keys of the key-value pairs stored in each of the plurality of computing nodes, for at least one key matching a known element of the query condition;
searching, in keys of the key-value pairs stored in each of the plurality of computing nodes, for at least one key matching another known element of the query condition; and
using at least one key-value pair corresponding to the at least one key matching the one known element and at least one key-value pair corresponding to the at least one key matching the another known element as key-value pair matching the query condition.

6. The method according to claim 5, wherein the acquiring a query result according to the elements corresponding to the query objects determined in each of the plurality of computing nodes comprises:
categorizing the elements corresponding to the query objects determined in each of the plurality of computing nodes according to the known elements of the query conditions to acquire elements corresponding to the query objects acquired according to each of the known elements of the query conditions; and
taking an intersection of the elements corresponding to the query objects acquired according to each of the known elements of the query conditions to acquire the query result.

7. The method according to claim 1, wherein there are a plurality of to-be-queried triples, the acquiring a query result according to the elements corresponding to the query objects determined in each of the plurality of computing nodes comprises:
acquiring the query result according to a relation between each two of the plurality of to-be-queried triples, and the elements corresponding to the query objects determined in each of the plurality of computing nodes for each of the plurality of to-be-queried triples.

8. The method according to claim 7, wherein the acquiring the query result according to a relation between each two of the plurality of to-be-queried triples, and the elements corresponding to the query objects determined in each of the plurality of computing nodes for each of the plurality of to-be-queried triples comprises:
if the relation between each two of the plurality of to-be-queried triples is an AND relation, taking an intersection of the elements corresponding to the query objects determined in each of the plurality of computing nodes for each of the plurality of to-be-queried triples to acquire the query result; and
if the relation between each two of the plurality of to-be-queried triples is an OR relation, and taking a union of the elements corresponding to the query objects determined in each of the plurality of computing nodes for each of the plurality of to-be-queried triples to acquire the query result.

9. The method according to claim 1, further comprising:
constructing the plurality of key-value pairs according to a triple of the ontology described with the RDF; and storing the constructed plurality of key-value pairs in the plurality of computing nodes.

10. The method according to claim 9, wherein the storing the constructed plurality of key-value pairs in the plurality of computing nodes comprises:
if there are at least two key-value pairs, whose keys and corresponding key values are the same, in the constructed plurality of key-value pairs, storing at least one of the at least two key-value pairs in the plurality of computing nodes.

11. The method according to claim 9, wherein the storing the constructed plurality of key-value pairs in the plurality of computing nodes comprises:
storing key-value pairs of the constructed plurality of key-value pairs, whose key is the same, in the same computing node.

12. An ontology-based query apparatus, wherein a plurality of key-value pairs constructed according to a triple of the ontology described with a resource description framework (RDF) are stored in a plurality of computing nodes respectively, each of the plurality of key-value pairs comprising a key and a key value, the key value comprising three elements of the triple, and the key comprising one of the three elements of the triple, the apparatus comprising:
a first acquiring module, configured to acquire at least one to-be-queried triple input by a user, wherein a known element in the to-be-queried triple is a query condition, and at least one unknown element in the to-be-queried triple is a query object;
a searching module, configured to search, in the key-value pairs stored in each of the plurality of computing nodes, for at least one key-value pair matching the query condition acquired by the first acquiring module;
a first determining module, configured to determine an element corresponding to the query object from three elements comprised in a key value of the matched key-value pair acquired by the searching module, to acquire elements corresponding to the query objects determined in each of the plurality of computing nodes; and
a second acquiring module, configured to acquire a query result according to the elements corresponding to the query objects determined by the first determining module in each of the plurality of computing nodes.

13. The apparatus according to claim 12, wherein there is one known element in the to-be-queried triple, and the query condition is the one known element in the to-be-queried triple,
the searching module is configured to search, in keys of the key-value pairs stored in each of the plurality of computing nodes, for at least one key matching a known element of the query condition, and use at least one key-value pair corresponding to the matched key as key-value pair matching the query condition.

14. The apparatus according to claim 13, wherein the second acquiring module is configured to combine the elements corresponding to the query objects determined in each of the plurality of computing nodes to acquire the query result.

15. The apparatus according to claim 12, wherein there are two known elements in the to-be-queried triple, and the query condition is the two known elements in the to-be-queried triple, the searching module comprises:
a first searching unit, configured to search, in keys of the key-value pairs stored in each of the plurality of computing nodes, for at least one key matching a known element of the query condition; and
a second searching unit, configured to search, in key values corresponding to the matched key searched by the first searching unit, for at least one key value matching another known element of the query condition, and use at least one key-value pair corresponding to the matched key value as key-value pair matching the query condition.

16. The apparatus according to claim 12, wherein there are two known elements in the to-be-queried triple, and the query condition is the two known elements in the to-be-queried triple,
the searching module is configured to search, in keys of the key-value pairs stored in each of the plurality of computing nodes, for at least one key matching a known element of the query condition, and search, in keys of the key-value pairs stored in each of the plurality of computing nodes, for at least one key matching another known element of the query condition, and use at least one key-value pair corresponding to the at least one key matching the one known element and at least one key-value pair corresponding to the at least one key matching the another known element as key-value pair matching the query condition.

17. The apparatus according to claim 16, wherein the second acquiring module comprises:
a categorizing unit, configured to categorize the elements corresponding to the query objects determined in each of the plurality of computing nodes according to the known elements of the query conditions to acquire elements corresponding to the query objects acquired according to each of the known elements of the query conditions; and
the first acquiring unit, configured to take an intersection of the elements corresponding to the query objects acquired by the categorizing unit according to each of the known elements of the query conditions to acquire the query result.

18. The apparatus according to claim 12, wherein there are a plurality of to-be-queried triples, and
the second acquiring module is configured to acquire the query result according to a relation between each two of the plurality of to-be-queried triples, and the elements corresponding to the query objects determined in each of the plurality of computing nodes for each of the plurality of to-be-queried triples.

19. The apparatus according to claim 18, wherein the second acquiring module comprises:
a second acquiring unit, configured to: take an intersection of the elements corresponding to the query objects determined in each of the plurality of computing nodes for each of the plurality of to-be-queried triples to acquire the query result if the relation between each two of the plurality of to-be-queried triples is an AND relation; and
a third acquiring unit, configured to: take a union of the elements corresponding to the query objects determined in each of the plurality of computing nodes for each of the plurality of to-be-queried triples to acquire the query result if the relation between each two of the plurality of to-be-queried triples is an OR relation.

20. The apparatus according to claim 12, further comprising:
a constructing module, configured to construct a triple of the plurality of key-value pairs according to the ontology described with the RDF; and
a storing module, configured to store the plurality of key-value pairs constructed by the constructing module in the plurality of computing nodes.

21. The apparatus according to claim 20, wherein the storing module is configured to: if there are at least two key-value pairs, whose keys and corresponding key values are the same, in the constructed plurality of key-value pairs, store at least one of the at least two key-value pairs in the plurality of computing nodes.

22. The apparatus according to claim 20, wherein the storing module is configured to: store key-value pairs of the constructed plurality of key-value pairs, whose key values are the same, in the same computing node.
